(19) United States
(12) Patent Application Publication
(10) Pub. No.: US 2025/0339894 A1
(43) Pub. Date: Nov. 6, 2025

(54) Riveting device, mandrel holder, and method for assembling a riveting device

(71) Applicant: SFS Group Germany GmbH, Oberursel (DE)

(72) Inventor: Robert KÖLM, Neu-Anspach (DE)

(73) Assignee: SFS Group Germany GmbH, Oberursel (DE)

(21) Appl. No.: 18/870,859

(22) PCT Filed: Jun. 29, 2023
(86) PCT No.: PCT/DE2023/100493

§ 371 Date: Dec. 2, 2024

(30) Foreign Application Priority Data
Jun. 30, 2022 (DE) 10 2022 116 417.9

(51) Int. Cl. B21J 15/10; B21J 15/04; B21J 15/26; B21J 15/32; B25B 27/00; B25F 5/00; B25F 5/02

(52) U.S. Cl. CPC B21J 15/105; B21J 15/043; B21J 15/26; B21J 15/326; B25B 27/0014; B25F 5/001; B25F 5/02

(57) ABSTRACT

A riveting device has a riveting tool and a drive device for actuating the riveting tool. A mandrel holder can be moved relative to the mouthpiece along an operative axis. The drive device has a drive element which is set up to be moved along the operative axis in order to drive the mandrel holder. The drive element is connected directly or indirectly via a screw connection to the mandrel holder and the screw connection is formed by rotating the mandrel holder and the drive element relative to each other around a rotational axis. A locking element is in a locking position in which the mandrel holder is mechanically blocked against rotation around the rotational axis relative to the drive element in a rotational position. The locking element is brought into the locking position by a movement performed radially relative to the rotational axis.

### CROSS-REFERENCE TO RELATED APPLICATION

This application is a national stage application, filed under 35 U.S.C. § 371, of International Patent Application PCT/DE2023/100493, filed on Jun. 29, 2023, which claims the benefit of German Patent Application DE 10 2022 116 417.9, filed on Jun. 30, 2022.

### TECHNICAL FIELD

The present disclosure refers to a riveting device and in particular a blind rivet setting tool, a blind rivet nut setting tool and a blind rivet screw setting tool. The present disclosure also relates to a mandrel holder and to a method for assembling a riveting device.

### BACKGROUND

Riveting devices are typically used to produce a rivet connection between two or more materials, such as for example metal sheets, at a connection point at which the materials are placed on each other. To form the rivet connection, a plastically deformable, often cylindrical connecting element is used which is generally referred to as a rivet. The rivet usually has a rivet head prefabricated on one end. To produce the rivet connection, the rivet is introduced into a connection hole at the connection point up to the rivet head and then the other end of the rivet is plastically deformed to form a closing head.

Riveting devices can also be used to provide components with a thin wall with a thread. Rivet nuts or rivet screws are used for this, with which a rivet is combined with an element comprising a thread. The rivet nuts or rivet screws are introduced into a prefabricated rivet hole of the component and subsequently a region of the rivet is plastically deformed to form a closing head.

Commonly used riveting devices usually comprise a riveting tool which is set up to cause a plastic deformation forming the closing head. The riveting devices have a drive device accommodated in a device housing for actuating the riveting tool. Often, the drive device is electromechanical and comprises, for example, an electric motor and a spindle gear that is formed as a ball screw drive and has a threaded spindle and a spindle nut. Typically, the spindle nut is driven by the electric motor and the threaded spindle is secured by torque arms against rotation, so that the threaded spindle shifts axially and thus acts on the riveting tool when the spindle nut rotates.

Such a riveting device is known from EP 0 527 414 A1. The riveting device is formed and set up for blind rivets, a rivet mandrel is pulled out from the rivet body of a blind rivet by exerting a pulling movement, using compression of the rivet body to create a closing head. The pulling movement is performed by a mandrel holder that is driven by the drive device via the threaded spindle and on which the rivet mandrel is fixed. The mandrel holder is received in a tool housing and is movably held therein in relation to a mouthpiece fixed on the tool housing for performing the pull movement. The rivet mandrel is inserted into the tool housing up to the mandrel holder via the mouthpiece and the riveting device is placed onto the point to be riveted.

The mandrel holder is typically one of the maintenance parts of the riveting device. Therefore, the mandrel holder is usually removed from time to time for maintenance and/or cleaning purposes. In order to facilitate removal and remounting, the mandrel holder is frequently screwed onto the front end of the threaded spindle, as is also the case with the known riveting device.

In order to lock the mandrel holder in a desired rotational position against rotation with respect to the threaded spindle, typically a locking mechanism is used. A locking mechanism is known from WO 02/098585 A2 which locks the mandrel holder in a desired rotational position against rotation with respect to the threaded spindle by way of an axial locking movement. Due to the design, the locking mechanism needs to be actively moved by a user for the purpose of unlocking. The locking mechanism also has a relatively large construction due to the axial locking movement in the axial direction.

### SUMMARY

In the course of continuous further development, there may therefore be a need to improve the compactness of a riveting device. This is based on the expectation that improved compactness will make it easier to reach hard-to-reach riveting points in order to set a rivet there. It is also expected that improved compactness will make the riveting device lighter and/or easier to handle and/or more convenient to handle.

An embodiment of a basic riveting device comprises a riveting tool and a drive device for actuating the riveting tool. For example, the riveting device, in particular the riveting tool, is suitable for blind riveting, during which, by means of a rivet mandrel, the riveting process is carried out from one side of the material to be provided with a blind rivet. A blind rivet nut or a blind rivet screw can also be used instead of a blind rivet.

Preferably, the riveting tool has a mouthpiece and a mandrel holder, that can be moved relative to the mouthpiece along or in the direction of an operative axis For example, the mandrel holder comprises a chuck housing that can be moved relative to the mouthpiece along or in the direction of the operative axis and at least one clamping element, in particular clamping jaw, that can be moved in the chuck housing along a clamping path.

Preferably, the drive device has a drive element which in particular is set up to be moved along the operative axis, in particular in order to drive the mandrel holder. The drive element can be a threaded spindle, for example, of a spindle gear, in particular of a ball screw drive. Alternatively, the drive element can be a reciprocating piston. The drive device may be an electromechanical drive device, for example having an electric motor, or a pneumatic drive device, for example having a pneumatic drive, or a hydraulic drive device, for example having a hydraulic drive.

Preferably, the drive element is directly or indirectly connected to the mandrel holder via a screw connection, for example via an intermediate element. In particular, the screw connection is formed by rotating the mandrel holder and the drive element relative to each other around a rotational axis. For example, the rotational axis is arranged coaxially to the operative axis or the rotational axis lies on the operative axis.

Preferably, the basic riveting device has a locking element. Preferably, the locking element is in a locking position or is brought into a locking position. In the locking position, the mandrel holder is preferably mechanically blocked against rotation around the rotational axis relative to the drive element in a preferably predetermined or specified rotational position.

An improvement in the compactness is provided by an embodiment of the riveting device in which the locking element has reached the locking position by a movement performed radially in relation to the rotational axis. Due to the radial movement direction of the locking element, the riveting device can have a more compact construction in the axial direction than would be possible with an axial movement direction of the locking element. This in turn favours the handling of the riveting device. Reaching difficult-to-access rivet points is also facilitated, in order to be able to set a rivet there.

In one embodiment, the screw connection comprises two connecting parts that have threads and that can be rotated relative to each other around the rotational axis, of which one connecting part is assigned to the mandrel holder and the other connecting part is assigned to the drive element. In particular, the one connecting part is arranged fixed on the mandrel holder, in particular formed thereon, for example moulded on. In particular, the other connecting part is arranged fixed on the drive element, in particular formed thereon, for example moulded on.

In this case, the improved riveting device can be designed so that the thread of one of the connecting parts is formed in a threaded bore and the one connecting part has a through hole extending radially from the threaded bore, in which the locking element is received so as to be radially moveable in relative to the rotational axis. In particular, the other connecting part has a recess on its circumference, such as for example a pocket, in which the locking element engages in a locking manner. Therefore, a technically simple embodiment is favoured in order to realise a radial locking movement of the locking element.

The improved riveting device can also be designed so that the recess and/or the locking element has an outlet contour in the circumferential direction in relation to at least one of the connecting parts. Therefore, an unlocking of the locking element is enabled in a simple manner by exerting a rotational force. This is because the locking element is pushed radially outwards from the recess by the outlet contour when a predetermined rotational force acts on the screw connection.

The improved riveting device can also be designed so that the connecting part provided with the recess has at least one, preferably several further recesses into which the locking element can be brought. Therefore, the mandrel holder can be locked into other rotational positions by a 360 degree rotation of the mandrel holder with respect to the drive element. Therefore, it is preferable that the mandrel holder can be locked as close as possible to a desired axial distance of the mandrel holder from the drive element and/or as close as possible to an axial stop for the mandrel holder. This also makes it possible to adjust the axial distance between the mandrel holder and the drive element in very small steps by locking the locking element in the corresponding recess depending on the desired axial distance.

The improved riveting device can also be designed so that the locking element engages in the locking position into a contour of the drive element and is disengaged therefrom in an unlocking position. An axial intermediate element can be dispensed with because the drive element is used directly for the locking. In this respect, this measure also aims to reduce the axial overall length of the riveting device.

The improved riveting device can also be designed so that the locking element is arranged outside of the screw connection in the axial direction in relation to the rotational axis. Therefore, the load capacity of the thread forming the screw connection remains uninfluenced by the locking element.

The improved riveting device can also be designed so that a spring ring surrounds the rotational axis and in particular acts resiliently radially in relation to the rotational axis. In particular, the spring ring is operatively connected to the locking element in the radial direction, so that the spring ring applies a radial force to the locking element in an unlocking position of the locking element in which the locking element is in a radially extended position. For example, the spring ring surrounds the connecting part provided with the through hole for the locking element and/or lies thereon. For example, the locking element has a groove in which the spring ring engages with a circumferential section. For example, the spring ring may be an O-ring.

These measures are designed to create a haptic sensation that evokes in the user the tactile perception of a latch. This is achieved, for example, in that the locking element is pushed against the force of the spring ring radially outwards from the locking position and automatically returning to the locking position by the force of the spring element when the user rotates the mandrel holder relative to the drive element around the rotational axis with a rotational axis overcoming the locking position. Also, the locking element can be held securely on the riveting device, in particular on the connecting part provided with the through hole, by the spring ring.

In a further embodiment, a tool housing is provided in which the mandrel holder is movably received along the operative axis. For example, the mouthpiece is arranged on an axial end of the tool housing, for example fixed or moulded onto it.

In this embodiment, the improved riveting device can be designed so that the spring ring is a sealing ring, which serves to seal the mandrel holder against the tool housing. Therefore, the spring ring provides a dual function. This dual function results in improved functional integration.

The improved riveting device can also be designed so that the tool housing extends in the direction to above the locking element, so that the locking element is secured against release from the locking position by the tool housing. Therefore, the sliding of the tool housing over the mandrel holder can be used in order to lock the locking element in the locking position at the same time. This means that a user does not need to perform a separate actuating step. Sliding the tool housing over the mandrel holder is a step to be performed while mounting the tool housing on the riveting device.

In order to secure the locking element against release from the locking position by sliding the tool housing onto the mandrel holder, the locking element is to have a longitudinal extension in the radial direction in relation to the rotational axis, which longitudinal extension is greater than the radial distance between the circumference of the threaded bore and the outer circumference of the connecting part provided with the threaded bore in the region of the through hole.

If the above-described spring ring acts on the locking element and in particular is arranged between the slid-on tool housing and the locking element, the longitudinal extension resulting from the locking element, and in particular from the spring element, should be greater in the radial direction in relation to the rotational axis than the radial distance between the circumference of the threaded bore and the outer circumference of the connecting part provided with the threaded bore in the region of the through hole.

Simple manufacture of the locking element, and in particular of the locking mechanism it causes, is aided when the locking element is cylindrical, the central axis of which is radial to the rotational axis.

In a further embodiment, the riveting device is formed as a hand riveting device and comprises a handle part, which for example has a longitudinal extension transverse to the operative axis. For example, the handle part is formed on the device housing, in particular moulded thereon. The riveting device can be held in the hand or manually guided by the handle part. In particular, the handle part allows the riveting device to be positioned manually at a point to be riveted.

Further progress results in principle in a method for assembling a riveting tool, in particular the above-described riveting tool, wherein the method comprises steps for
i) connecting the mandrel holder and the drive element of the riveting device by creating a screw connection;
ii) rotating the mandrel holder and the drive element relative to each other around the rotational axis until a desired rotational position of the mandrel holder with respect to the drive element is achieved and the locking element is snapped into a locking position in which the mandrel holder is blocked against rotation around the rotational axis relative to the drive element.

Therefore, the handling for a user is improved in order to mount the mandrel holder on the drive element and to lock the mandrel holder at a desired axial distance from the drive element. This merely requires the rotational movement, which is to be performed anyway in the course of the screwing together to produce the screw connection. The separate actuating movement is not required by the user to actuate the locking element.

Even more progress results in a further development of the method, in which step ii) comprises sub-steps for
ii.1) rotating the mandrel holder and the drive element relative to each other around the rotational axis up to an axial stop;
Iii.2) rotating the mandrel holder and the drive element relative to each other around the rotational axis away from the axial stop until a desired rotational position of the mandrel holder with respect to the drive element is achieved and the locking element reaches a locking position in which the mandrel holder is blocked against rotation around the rotational axis relative to the drive element.

This approach aims to further simplify or facilitate the setting of the axial distance of the mandrel holder from the drive element for the user.

Even further progress results in a further development of the method, in which a step is comprised, after performing step ii) or sub-steps ii.1) and ii.2), for
iii) sliding the tool housing to above the locking element in order to secure the locking element against a release from the locking position.

Therefore, mounting the tool housing on the riveting device or the support structure is used in order to achieve a final locking of the mandrel holder. The user does not need to perform any separate actuating movement or locking movement for this final locking.

According to one aspect, a mandrel holder for the above-described riveting device is proposed. The mandrel holder comprises a cylindrical base body having a section for receiving a rivet mandrel or threaded rivet mandrel and having a threaded bore for producing a screw connection with the drive element of the riveting device.

In the proposed mandrel holder, the base body has a through hole which extends radially outwards from the threaded bore and is set up to movably receive a locking element in the direction of the threaded bore. For example, the mandrel holder comprises a locking element which is received in the through hole. Therefore, the mandrel holder is suitable for mounting with the above-described riveting device and for achieving the above-described advantages.

According to a further aspect, a blind rivet setting tool is proposed. The blind rivet setting tool comprises the above-described riveting device and has a rivet mandrel received in its mandrel holder of a blind rivet to be set.

According to a further aspect, a blind rivet nut setting tool is proposed. The blind rivet nut setting tool comprises the above-described riveting device and has a threaded rivet mandrel received in its mandrel holder for a blind rivet nut to be set.

According to a further aspect, a blind rivet screw setting tool is proposed. The blind rivet screw setting tool comprises the above-described riveting device and has a threaded rivet mandrel received in its mandrel holder of a blind rivet screw to be set.

Further characteristics and features result from the following description of several exemplary embodiments with reference to the drawing.

### BRIEF DESCRIPTION OF THE DRAWINGS

FIG. 1 shows an exemplary embodiment of a riveting device having a riveting tool and a drive device for actuating the riveting tool in a schematic sectional representation,

FIG. 2 shows the exemplary riveting device in an enlarged section of FIG. 1 in the region of a tool housing with a mandrel holder received therein and a locking element for the mandrel holder in a locking position,

FIG. 3 shows the exemplary riveting device in a sectional representation along the section line X-X of FIG. 2,

FIG. 4 shows the exemplary riveting device in the representation according to FIG. 2 with the tool housing removed, wherein the locking element is in an unlocking position,

FIG. 5 shows the exemplary riveting device in a sectional representation along the section line X-X of FIG. 4,

FIG. 6 shows the exemplary riveting device in the representation according to FIG. 2 with the tool housing removed, wherein the locking element is in the locking position,

FIG. 7 shows the exemplary riveting device in a sectional representation along the section line X-X of FIG. 6,

FIG. 8 shows a possible embodiment of a blind rivet setting tool having the exemplary riveting device of FIG. 1 in a schematic partial representation,

FIG. 9 shows a possible embodiment of a blind rivet nut setting tool having the exemplary riveting device of FIG. 1 in a schematic partial representation, and

FIG. 10 shows a possible embodiment of a blind rivet screw setting tool having the exemplary riveting device of FIG. 1 in a schematic partial representation.

### DETAILED DESCRIPTION

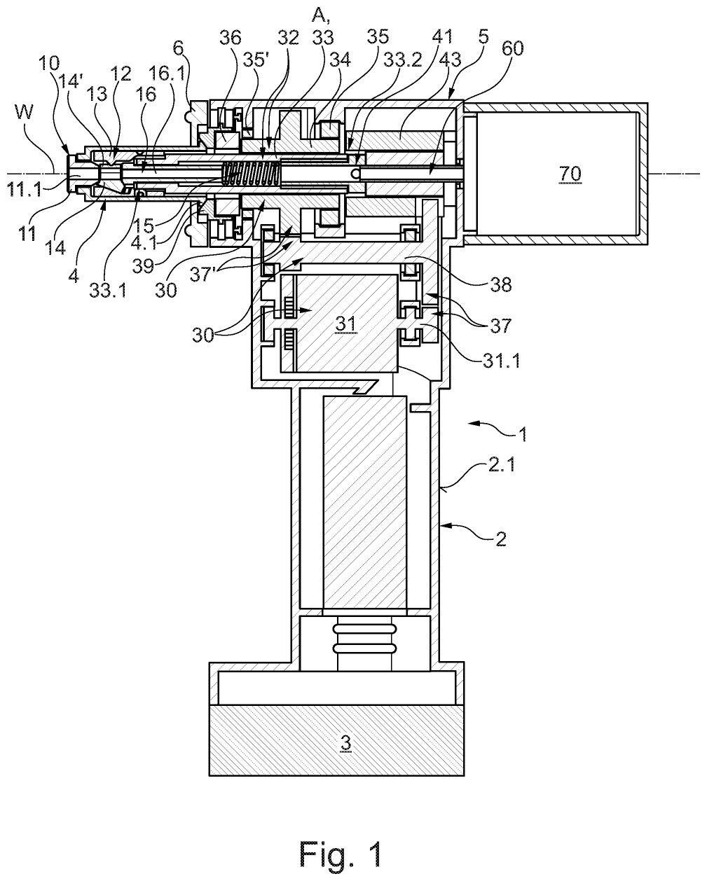

FIG. 1 shows the construction of an exemplary embodiment of a riveting device 1 which is also referred to as a setting device by experts. The exemplary riveting device 1 is suitable for applying or setting rivets according to the blind riveting method, and in this regard is designed for using blind rivets.

The exemplary riveting device 1 comprises a riveting tool 10 and a drive device 30 for actuating the riveting tool 10. Preferably, the riveting tool 10 is assigned to a tool housing 4. Preferably, the drive device 30 is assigned to a device housing 5, in particular received therein. Preferably, the tool housing 4 is a metal housing. Preferably, the device housing 5 is a plastic housing.

The exemplary riveting device 1 can be a hand riveting device. The hand riveting device 1 has a gripping surface 2.1 which can be formed at least partially on the device housing 5. For example, the hand riveting device 1 has a handle part 2 which is at least partially formed by the device housing 5. The riveting device 1 can be held in the hand by the gripping surface 2.1 or the handle part 2 when it is used for setting a rivet, in particular a blind rivet on a workpiece. The riveting process takes place then by actuating the riveting tool 10 via the drive device 30.

For example, the drive device 30 is an electromechanical drive device. The electromechanical drive device 30 comprises, for example, an electric motor 31 having a rotatable output shaft 31.1 and preferably a spindle gear 32, which can be driven by the electric motor 31. Preferably, the spindle gear 32 is set up to convert a rotational drive movement coming from the output shaft 31.1 into a translational drive movement which acts along an operative axis W to actuate the riveting tool 10. The spindle gear 32 can be a ball screw drive.

In the exemplary riveting device 1, for example at least one, preferably two reduction stages 37, 37′ can be interposed between the electric motor 31 and the spindle gear 32. For example, the reduction gears 37, 37′ are connected in series in the force flow. For example, the reduction stages 37, 37′ use a common intermediate shaft 38. For example, at least one of the reduction stages 37, 37′ is a spur gear stage and the associated gear elements are spur gears.

A preferably replaceable electrical energy storage device, such as an accumulator 3, can be provided for the electrical energy supply of the drive device 30, which energy storage device is arranged, for example, in the region of an end of the handle part 2 facing away from the riveting tool 10. Therefore, the riveting device 1 can be a cordless tool.

The riveting tool 10 can comprise a mouthpiece 11 and a mandrel holder 12 that can be moved relative to the mouthpiece 11 in the direction of the operative axis W. For example, the mandrel holder 12 has a chuck housing 13 and at least one, preferably several clamping elements 14, 14′, in particular clamping jaws, which can be moved in the chuck housing 13 along a clamping path. Preferably, the mouthpiece 11 and/or the mandrel holder 12 and/or the chuck housing 13 and/or the clamping elements 14, 14′ are a metal part.

The mouthpiece 11 is used, for example, to receive a rivet (not shown in FIG. 1) to be set, in particular a blind rivet, and preferably has a through hole 11.1, in order to insert the rivet mandrel of the rivet therein. The mandrel holder 12 serves, for example, to fix the rivet mandrel, so that a non-displaceable connection between the received rivet mandrel and the mandrel holder 12 is created. This can take place, for example, via the chuck housing 13 with the clamping elements 14, 14′ arranged movably therein, by means of which the rivet mandrel is fixed in the chuck housing 13, in particular is clamped therein.

The riveting tool 10 can be actuated by the drive device 30 so that the mandrel holder 12 or the chuck housing 13 with the rivet mandrel fixed therein is moved away from the mouthpiece 11, in the direction of the operative axis W. This happens, for example, by the drive device 30 pulling the mandrel holder 12 or the chuck housing 13 away from the mouthpiece 11. This mode of operation, which is known per se, and the blind riveting which can be carried out with it is described in more detail in the publication EP 0 116 954 A2, to which reference is hereby made for the purpose of completing and supplementing the present disclosure, with the note that the publication may attach a meaning to identically worded terms which differs from the present meaning.

Preferably, the mouthpiece 11 is fixed to the tool housing 4, for example screwed to it. Preferably, the mandrel holder 12, in particular the chuck housing 13, is received in the tool housing 4 so as to be moveable in the direction of the operative axis W. For example, the tool housing 4 has an elongate, in particular tubular base body. In this respect, the tool housing 4 is also referred to as a setting sleeve by experts. For example, the mouthpiece 11 is fixed on one end of the tool housing 4 and the opposing end faces towards the device housing 5.

Preferably, the spindle gear 32 is arranged in the device housing 5. Preferably, the spindle gear 32 comprises a threaded spindle 33 having a feed thread and a spindle nut 34 that is or can be engaged therewith. Preferably, the threaded spindle 33 has a front end 33.1, facing towards the mandrel holder 12, in particular the chuck housing 13, and an opposing back end 33.2. Preferably, the threaded spindle 33 and the spindle nut 34 are arranged concentrically to each other with regard to a transmission axis. Preferably, the spindle axis of the threaded spindle 33 is on the transmission axis. Preferably, the output shaft 31.1 of the electric motor 31 is arranged axially parallel to the transmission axis. Preferably, the transmission axis or the spindle axis lies on the operative axis W.

For example, the threaded spindle 33 and the spindle nut 34 are set up in such a way that the spindle nut 34 is the gear element that is or can be driven by the electric motor 31 and the threaded spindle 33 is used for performing the translational drive movement in order to actuate the riveting tool 10. For this purpose, for example, the threaded spindle 33 is non-displaceably connected directly or indirectly to the mandrel holder 12 or the chuck housing 13, at its front end 33.1, for example via an intermediate piece. For example, the spindle nut 34 is also rotatably mounted in the radial direction relative to the transmission axis or the operative axis W via at least one, preferably two radial bearings 35, 35′ in the device housing 5.

In the exemplary riveting device 1, a torque arm 41 is provided, for example, in order to secure the threaded spindle 33 against rotation relative to the device housing 5. For example, the torque arm 41 is arranged on the threaded spindle 33, in particular fixed thereon or connected thereto in a rotationally fixed manner. For example, the torque arm 41 is supported against a counter bearing 43, preferably via at least one sliding body or roll body, in order to secure the threaded spindle 33 against rotation. The counter bearing 43 itself can be arranged rotationally fixed or secured against rotation with respect to the device housing 5. For example, the counter bearing 43 has at least one guide track on which the torque arm 41 is guided while maintaining the anti-rotation protection when the threaded spindle 33 performs a translational movement along the operative axis W.

In the exemplary riveting device 1, a spring element 15 is provided, for example, which acts with a force into the mandrel holder 12, for example via a pressure part 16. For example, the spring element 15 is arranged in the threaded spindle 33. For example, the threaded spindle 33 and/or the torque arm 41 serves as a counter holder for the spring element 15.

The force of the spring element 15 can be used as a pretension force which causes or at least supports the rivet mandrel to be fixed in the mandrel holder 12. For example, the spring element 15 is provided in order to apply a spring force to the clamping elements 14, 14′ inside the chuck housing 13. Therefore, the clamping elements 14, 14′ are pushed into a clamping position against a rivet mandrel, for example of a blind rivet, introduced via the through hole 11.1 of the mouthpiece 11 into the chuck housing 13. For example, the spring element 15 is compression spring.

Preferably, the threaded spindle 33 is formed as a hollow spindle with a through hole 40 extending in the direction of its longitudinal extension. The through hole 40 makes it possible to remove any rivet mandrel remnants remaining from a riveting process from the riveting tool 10. In this case, for example, the pressure part 16 arranged on the front end 33.1 of the threaded spindle 33 is received in the through hole 40 and itself is formed as a hollow body having a through hole 16.1.

For example, the through hole 40 on the back end 33.2 of the threaded spindle 33 leads into a tubular element 60, which in turn leads into a collection container 70. For example, in this manner, a mandrel removal path is realised via the threaded spindle 33, and the collection container 70 can serve as a collector for mandrel remnants. Preferably, the collection container 70 is arranged fixed integral with the housing relative to the device housing 5, in particular arranged releasably, for example, fixed on the device housing 5, in particular releasably fixed.

For example, the torque arm 41 is also formed as a hollow body having a through hole which is a component of the mandrel removal path to the collection container 67. For example, the torque arm 41 engages into the through hole 40 of the threaded spindle 33 and the tubular element 60 engages into the through hole of the torque arm 41.

In the exemplary riveting device 1, a support structure 39 is provided, for example, on which the tool housing 4 and an axial bearing 36, preferably formed as a thrust bearing, are supported axially with respect to the operative axis W, which axial bearing in turn is supported axially on the spindle nut 34. The mouthpiece 11 is therefore mounted on the axial bearing 36 via the tool housing 4 and the support structure 39, which axial bearing is in turn is supported on the spindle nut 34. In this manner, a load path is formed for the setting force occurring during a riveting process by bypassing or mostly bypassing the device housing 5.

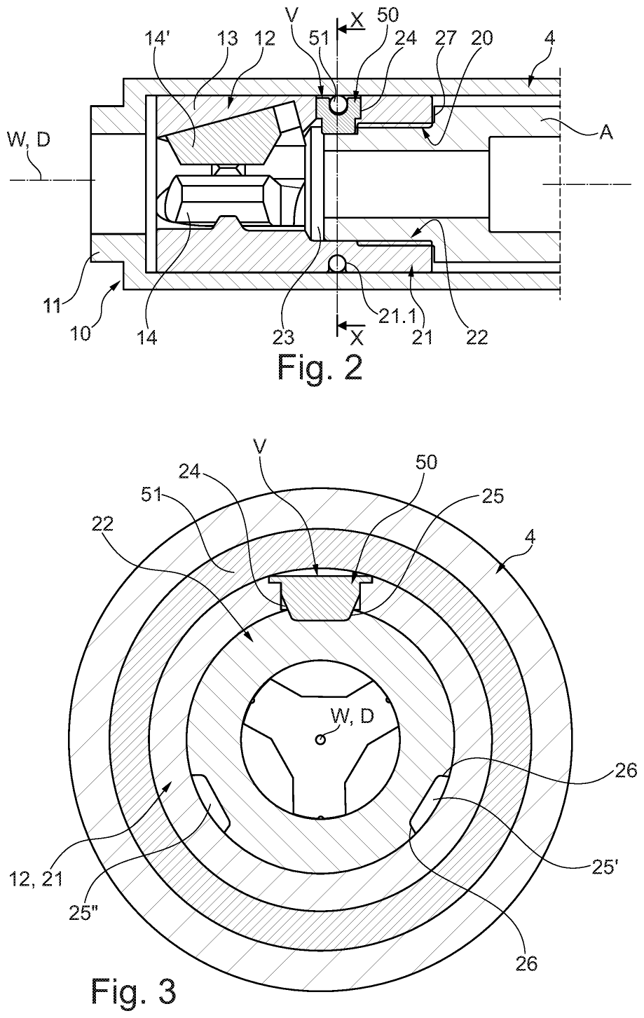

FIG. 2 shows the exemplary riveting device 1 in the region of the tool housing 4 in an enlarged section of FIG. 1. For the sake of clarity, the representation of FIG. 2 is simplified in comparison to FIG. 1, by omitting components and further schematisation. Furthermore, in FIG. 2, the threaded spindle 33 of FIG. 1 is generalised and subsequently as a whole is referred to as drive element A. This is against the background that the drive element A can in principle also be a reciprocating piston or another drive element that drives the mandrel holder. The reciprocating piston can be used as a threaded spindle 33 instead. Alternatively, the reciprocating piston can be driven pneumatically. For example, the reciprocating piston is used with a riveting device having a pneumatic drive device.

In particular, as can be seen from FIG. 2, the drive element A is connected to the mandrel holder 12 via a screw connection 20. The screw connection 20 is formed by rotating the mandrel holder 12 and the drive element A relative to each other around the rotational axis D. For example, the rotational axis D lies on the operative axis W.

Preferably, the screw connection 20 comprises two connecting parts 21, 22 that have threads and can be rotated with respect to each other around the rotational axis D. For example, one of the connecting parts 21, 22 is assigned to the mandrel holder 12 and the other connecting part 22 is assigned to the drive element A. For example, the one connecting part 21 is formed on the mandrel holder 12, in particular moulded thereon.

For example, the other connecting part 22 is formed on the drive element A, in particular moulded thereon.

For example, the thread of one of the connecting parts 21, 22, in particular the thread of the connecting part 21 assigned to the mandrel holder 12, is formed in a threaded bore 23. For example, the threaded bore 23 is in the centre relative to the rotational axis D and/or coaxial to the rotational axis D. For example, the thread of the other connecting part 22 is formed as an external thread.

For example, in order to prevent disengagement of the screw connection 20 and/or to continuously hold the connecting parts 21, 22 relative to each other in a desired rotational position and thus the mandrel holder 12 and the drive element A at a desired axial distance, a locking element 50 is provided. In FIG. 2, the locking element 50 is in a locking position V, in which the mandrel holder 12 is mechanically blocked against rotation around the rotational axis D relative to the drive element A in a rotational position.

In the exemplary riveting device 1, the riveting tool 10 is set up such that the locking element 50 is brought into the locking position V by a movement performed radially relative to the rotational axis D. Therefore, a compact construction of the riveting device 1 is favoured in the axial direction, since the locking movement of the locking element 50 which requires installation space is performed in the radial direction in relation to the rotational axis D and similarly is not performed in the axial direction.

In order to enable locking in this way, a through hole 24 is provided in the connecting part 21 assigned to the mandrel holder 12, for example. For example, the through hole 24 leads with one end into the threaded bore 23. For example, the through hole 24 extends radially outwards from the threaded bore 23. For example, the through hole 24 leads outside the screw connection 20 into the threaded bore 23, in the axial direction in relation to the rotational axis D. For example, the locking element 50 is received so as to be radially moveable in the through hole 24 in relation to the rotational axis D. With regard to the other connecting part 22, a recess 25 is provided there on the circumference, in which the locking element 50 engages in a locking manner.

To illustrate the radial construction of the riveting tool 10 in the region of the locking element 50, FIG. 3 shows the exemplary riveting device 1 in a sectional representation along the section line X-X of FIG. 2. In particular, as can be seen from FIG. 3, the connecting part 21 provided with the recess 25 can have at least one, preferably several further recesses 25′, 25″, into which the locking element 50 can be brought. The axial distance of the mandrel holder 12 to the drive element A can be adjusted in small steps to a desired value by the multiple recesses 25, 25′, 25″, whereby the locking element 50 is locked in the respective rotational position, at the respectively set value.

Preferably, the at least one recess 25 or 25′ or 25″ and/or the locking element 50 has an outlet contour 26 or 26′ in the circumferential direction in relation to at least one of the connecting parts 21, 22 (FIGS. 3 and 5), so that the locking element 50 is pushed radially outwards from the recess 25 via the outlet contour 26 or 26′, when a predetermined rotational force is exerted on the screw connection 20, for example by a user. Unlocking the locking element 50 with a rotational force exerted on the screw connection 20 is enabled by the outlet contour 26 or 26′, which force is applied anyway in the course of rotating the screw connection 20 in order to mount the mandrel holder 12 on the drive element A. A separate or other type of unlocking movement for unlocking the locking element 50 is thus eliminated.

In the exemplary riveting device 1, the connecting part 21 assigned to the mandrel holder 12 is surrounded by a spring ring 51, for example. Preferably, the spring ring 51 acts resiliently radially in relation to the rotational axis D. For example, the spring ring 51 may be an O-ring. Preferably, the spring ring 51 is operatively connected to the locking element 50 in the radial direction. For example, the locking element 50 has a cavity 53 or another recess, in which the spring ring 56 engages, in its one axial end face. For example, a circumferential groove 21.1 is provided on the connecting part 21 assigned to the mandrel holder 12, in which groove the spring ring 51 is received. In this respect, the spring ring 51 can serve as a sealing ring which seals the mandrel holder 12 against the tool housing 4. Furthermore, the spring ring 51 enables securing of the locking element 50 against falling out from the through hole 24.

Due to the spring effect of the spring ring 41, the tactile perception of a latching effect is suggested to a user in the course of a rotational movement of the mandrel holder 12 relative to the drive element A around the rotational axis D. Therefore, the user feels when the locking element 50 is brought into a locking position V, in the respective rotational position of the mandrel holder 12 against the drive element A. In this manner, the user can set the axial distance between the mandrel holder 12 and the drive element A relatively precisely in small steps.

In the exemplary riveting device 1, the locking element 50 is, for example, cylindrical and its central axis extends radially to the rotational axis D. For example, the locking element 50 has a contact surface 52 that extends transverse to its central axis and is supported in the through hole 24 against a shoulder 24.1 when the locking element 50 is located in the locking position V. Therefore, the locking element 50 is secured against falling through into the threaded bore 23, for example when the mandrel holder 12 is removed from the riveting device 1.

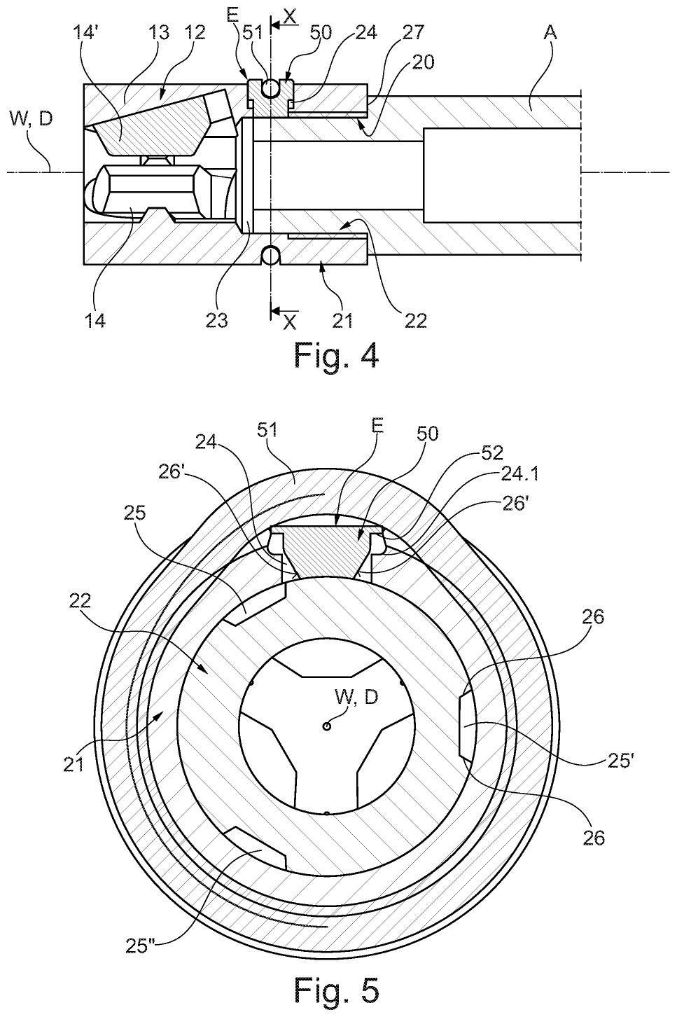

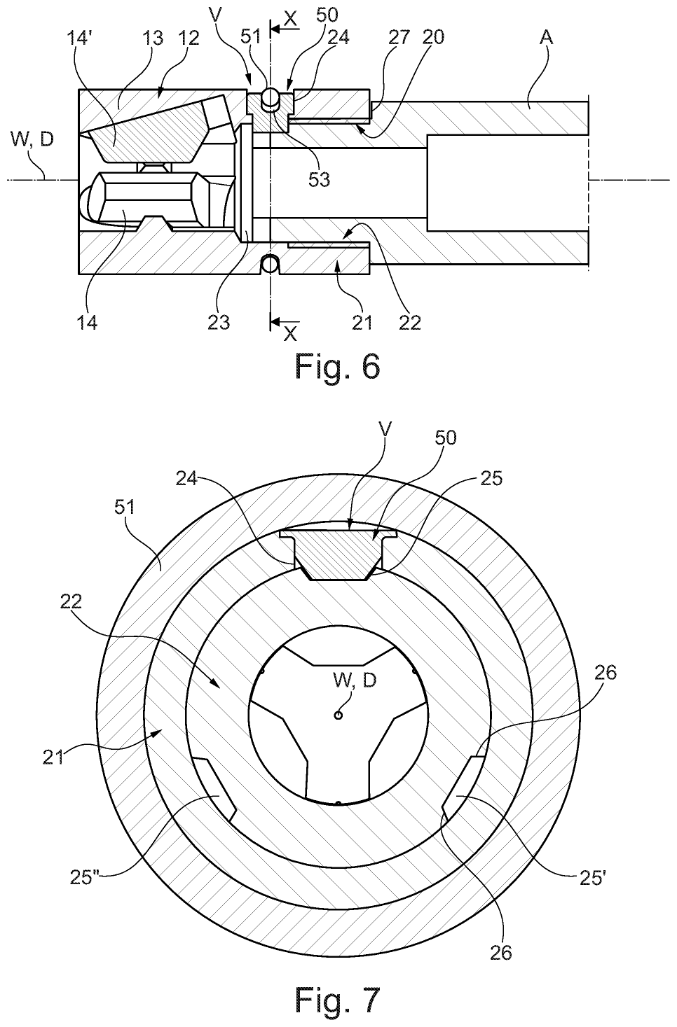

One possible approach, when mounting the mandrel holder 12 and the tool housing 4, is subsequently described by way of example using FIGS. 4 to 7. FIG. 4 shows the exemplary riveting device 1 with the tool housing 4 removed, wherein the locking element 50 is located in an unlocking position E. FIG. 5 shows the exemplary riveting device 1 in a sectional representation along the section line X-X of FIG. 4. FIG. 6 shows the exemplary riveting device 1 with the tool housing 4 removed, wherein the locking element 50 is located in the locking position V. FIG. 7 shows the exemplary riveting device 1 in a sectional representation along the section line X-X of FIG. 6.

Mounting the riveting tool 10 on the drive device 30 of the exemplary riveting device can take place, for example, in such a way that the mandrel holder 12 and the drive element A are connected to each other by creating the screw connection 20 in a first step. In this case, the mandrel holder 12 and the drive element A are rotated against each other relative to each other around the rotational axis D up to an axial stop 27. This state is shown in FIGS. 4 and 5. On reaching the axial stop 27, the locking element 50 is located in an unlocking position E. The axial stop 27 can be formed by a shoulder in the drive element A, against which the connecting part 21 provided with the threaded bore 23 abuts when the connecting part 21 is completely screwed onto the other connecting part 22.

In the unlocking position E, the locking element 50 is in a radially extended position, in which the locking element 50 is disengaged from the at least one recess 25 or 25′ or 25″ of the connecting part 22 assigned to the drive element A. The spring ring 51 applies a radial force on the locking element 50 in the unlocking position E in the inward direction.

In a further step, the mandrel holder 12 is now rotated around the rotational axis D away from the axial stop 27 relative to the drive element A until the mandrel holder 12 achieves a desired rotational position relative to the drive element A and preferably the locking element 50 is brought into the locking position V in one of the recesses 25, 25′, 25″. In this rotational position, the mandrel holder 12 is then blocked against rotation around the rotational axis D relative to the drive element 50. This state is shown in FIGS. 6 and 7.

Preferably, the tool housing 4 is then slid at least as far as over the locking element 50. This sliding takes place in the course of mounting the tool housing 4 on the riveting device 1. The locking element 50 is secured against release from the locking position V at the same time by sliding. This state is shown in FIGS. 2 and 3. In order to achieve this securing, the locking element 50 preferably has a longitudinal extension in the radial direction in relation to the rotational axis D, which extension is greater than the radial distance S between the circumference of the threaded bore 23 and the outer circumference of the connecting part 21 provided with the threaded bore 23 in the region of the through hole 24.

The proposed riveting device 1 enables a tool-free replacement of the mandrel holder 12 and the tool housing 4, wherein locking of the mandrel holder 12 against rotation around the rotational axis D with respect to the drive element A is enabled, which is optimised in its axial installation space requirement.

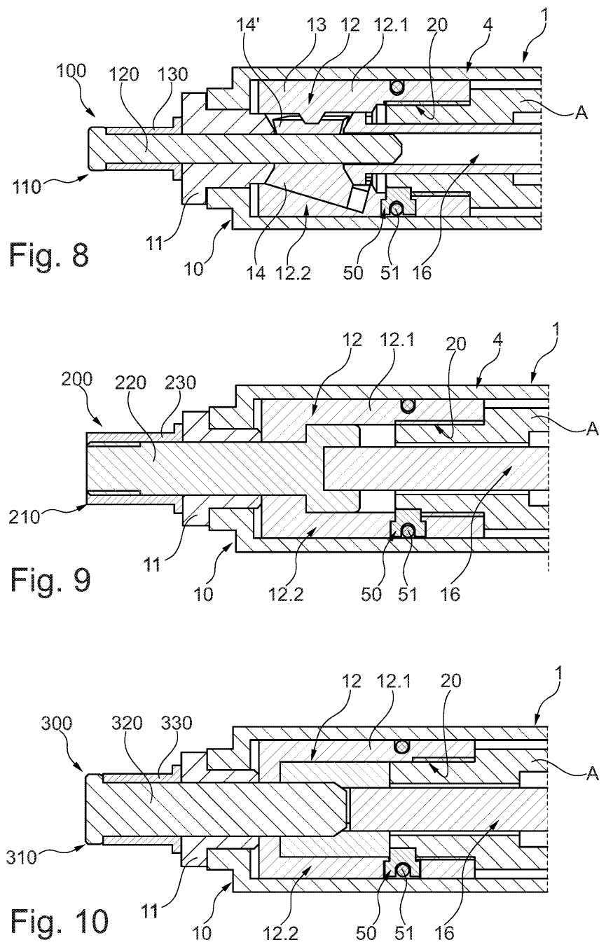

FIG. 8 shows an example of a possible embodiment of a blind rivet setting tool 100. The blind rivet setting tool 100 has the construction of the above-described exemplary riveting device 1, with only a section of the exemplary riveting device 1 being shown in the region of the riveting tool 10 in FIG. 8 for simplicity. In the blind rivet setting tool 100, a rivet mandrel 120 of a blind rivet 110 is introduced into the mouthpiece 11 and received in the mandrel holder 12, in particular the chuck housing 13, and fixed in the axial direction, for example by the at least one clamping element 14 or 14′. FIG. 8 shows the blind rivet 110 in the state before riveting, in which the rivet body 130 of the blind rivet 110 is still in its initial state.

FIG. 9 shows an example of a possible embodiment of a blind rivet nut setting tool 200. The blind rivet nut setting tool 200 has the construction of the above-described riveting device 1, wherein the mandrel holder 12 and the pressure part 16 are modified with regard to a rivet mandrel for a blind rivet nut and the rivet mandrel is a threaded rivet mandrel. For example, the pressure part 16 has a function there with regard to threading the threaded rivet mandrel into the blind rivet nut. In FIG. 9, only a section of the riveting device 1 is shown in the region of the riveting tool 10 for simplicity. With the blind rivet nut setting tool 200, a threaded rivet mandrel 220 for a blind rivet nut 210 is received in the mandrel holder 12. FIG. 9 shows the blind rivet nut 210 in the state before riveting, in which the rivet body 230 of the blind rivet nut 210 is still in its initial state.

For example, with the exemplary blind rivet nut setting tool 200, the pressure part 16 is introduced into a receptacle of the threaded rivet mandrel 220 and forms a positive-locking rotationally-fixed connection to the threaded rivet mandrel 220 via the receptacle. For example, the pressure part 16 is held in the receptacle of the threaded rivet mandrel 220 by the force of the spring element 15 of the riveting device 1 (FIG. 1), which acts axially on the pressure part 16.

FIG. 10 shows an example of a possible embodiment of a blind rivet screw setting tool 300. The blind rivet screw setting tool 300 has the construction of the above-described exemplary riveting device 1, wherein the mandrel holder 12 and the pressure part 16 are modified with regard to a rivet mandrel of a blind rivet screw and the rivet mandrel is a threaded rivet mandrel. For example, the pressure part 16 has a function there with regard to threading the threaded rivet mandrel into a screw-in part of the mandrel holder 12. In FIG. 10, only a section of the riveting device 1 is shown in the region of the riveting tool 10 for simplicity. With the blind rivet screw setting tool 300, a threaded rivet mandrel 320 of a blind rivet screw 310 is received in the mandrel holder 12 via the screw-in part. FIG. 10 shows the blind rivet screw 310 in the state before riveting, in which the rivet body 330 of the blind rivet screw 310 is still in its initial state.

For example, with the exemplary blind rivet screw setting tool 300, the pressure part 16 acts on the screw-in part, in particular the pressure part 16 is introduced into a receptacle of screw-in part and forms a positive-locking rotationally-fixed connection to the screw-in part via the receptacle. For example, the pressure part 16 is held in the receptacle of the screw-in part by the force of the spring element 15 of the riveting device 1 (FIG. 1), which acts axially on the pressure part 16.

As can be seen from FIGS. 8 to 10, the mandrel holder 12 has a cylindrical base body 12.1 which, for example, has a section 12.2 for receiving a rivet mandrel 120 or a threaded rivet mandrel 220 or 320 and the above-described threaded bore 23 for producing the screw connection 20 with the drive element A of the riveting device 1. The base body 12.1 can also have the above-described through hole 24 which extends radially outwards from the threaded bore 23 and is set up to movably receive the locking element 50 in the direction of the threaded bore 23. The above-described spring ring 51 can be wound in the region of the locking element 50 around the base body 12.1.

### REFERENCE NUMERAL LIST

1 riveting device
2 handle part
2.1 gripping surface
3 accumulator
4 tool housing
4.1 flange
5 device housing
6 retaining structure
10 riveting tool
11 mouthpiece
11.1 through hole
12 mandrel holder
12.1 base body
12.2 section
13 chuck housing
14, 14′ clamping element
15 spring element
16 pressure part
16.1 through hole
20 screw connection
21 connecting part
21.1 groove
22 connecting part
23 threaded bore
24 through hole
24.1 shoulder
25 recess
25′, 25″ recess
26, 26′ outlet contour
27 axial stop
30 drive device
31 electric motor
31.1 output shaft
32 spindle gear
33 threaded spindle
33.1 front end
33.2 back end
34 spindle nut
35, 35′ radial bearing
36 axial bearing
37, 37′ reduction stage
38 intermediate shaft
39 support structure
40 through hole
41 torque arm
43 counter bearing
50 locking element
51 spring ring
52 contact surface
53 cavity
60 tubular element
70 collection container
100 blind rivet setting tool
110 blind rivet
120 rivet mandrel
130 rivet body
200 blind rivet nut setting tool
210 blind rivet nut
220 threaded rivet mandrel
230 rivet body
300 blind rivet screw setting tool
310 blind rivet screw
320 threaded rivet mandrel
330 rivet body
A drive element
S radial distance
W operative axis
D rotational axis
V locking position
E unlocking position

1.-19. (canceled)

20. A riveting device (1), comprising:
a riveting tool (10), having
a mouthpiece (11) and
a mandrel holder (12),
wherein the mandrel holder (12) can be moved relative to the mouthpiece (11) along an operative axis (w);
a drive device (30) for actuating the riveting tool (10), having
a drive element (A),
wherein the drive element (A) is set up to be moved along the operative axis (W) in order to drive the mandrel holder (12),
wherein the drive element (A) is connected directly or indirectly via a screw connection (20) to the mandrel holder (12), and
wherein the screw connection (20) is formed by rotating the mandrel holder (12) and the drive element (A) relative to each other around a rotational axis (D); and
a locking element (50) which is in a locking position (V) in which the mandrel holder (12) is mechanically blocked against rotation around the rotational axis (D) relative to the drive element (A) in a rotational position,
wherein the locking element (50) is brought into the locking position (V) by a movement performed radially relative to the rotational axis (D).

21. The riveting device according to claim 20,
wherein the screw connection (20) comprises two connecting parts (21, 22) that have threads and that can be rotated relative to each other around the rotational axis (D),
wherein one connecting part (21) of the two connecting parts (21, 22) is assigned to the mandrel holder (12) and another connecting part (22) of the two connecting parts (21, 22) is assigned to the drive element (A),
wherein the thread of one of the two connecting parts (21, 22) is formed in a threaded bore (23) and wherein the one connecting part (21) has a through hole (24) extending radially from the threaded bore,
wherein the locking element (50) is received in the through hole (24) so as to be radially moveable relative to the rotational axis (D),
wherein the other connecting part (22) has a recess (25) on its circumference, and
wherein the locking element (50) engages in a locking manner in the recess (25).

22. The riveting device according to claim 21,
wherein the locking element (50) has in a radial direction in relation to the rotational axis (D) a longitudinal extension which is greater than a radial distance(S) between the circumference of the threaded bore (23) and an outer circumference of the one connecting part (21) provided with the threaded bore (23) in a region of the through hole (24).

23. The riveting device according to claim 21,
wherein the recess (25) and/or the locking element (50) has an outlet contour (26; 26′) in a circumferential direction relative to at least one of the connecting parts (21, 22).

24. The riveting device according to claim 21,
wherein the one connecting part (21) provided with the recess (25) has at least one further recess (25′, 25″) into which the locking element (50) can be brought.

25. The riveting device according to claim 20,
wherein the locking element (50) engages in the locking position (V) into a contour of the drive element (A) and is disengaged therefrom in an unlocking position (E).

26. The riveting device according to claim 20,
wherein the locking element (50) is arranged outside of the screw connection (20) in an axial direction relative to the rotational axis (D).

27. The riveting device according to claim 20,
further comprising a spring ring (51) which surrounds the rotational axis (D), acts resiliently radially in relation to the rotational axis (D) and is operatively connected to the locking element (50) in a radial direction, so that the spring ring (51) applies a radial force to the locking element (50) in an unlocking position (E) of the locking element (50) in which the locking element (50) is in a radially extended position.

28. The riveting device according to claim 27,
wherein the spring ring (51) is a sealing ring which serves to seal the mandrel holder (12) with respect to a tool housing (4) in which the mandrel holder (12) is received movably along the operative axis (W).

29. The riveting device according to claim 20,
further comprising a tool housing (4) which movably receives the mandrel holder (12) along the operative axis (W) and extends in the direction of the operative axis (W) to above the locking element (50), so that the locking element (50) is secured against release from the locking position (V) by the tool housing (4).

30. The riveting device according to claim 20,
wherein the locking element (50) is cylindrical, and
wherein a central axis of the locking element (50) is radial to the rotational axis (D).

31. A method for assembling the riveting tool according to claim 20, comprising:
i) connecting the mandrel holder (12) and the drive element (A) by creating the screw connection (20);
ii) rotating the mandrel holder (12) and the drive element (A) relative to each other around the rotational axis (D) until a desired rotational position of the mandrel holder (12) with respect to the drive element (A) is achieved and the locking element (50) is snapped into the locking position (V) in which the mandrel holder (12) is blocked against rotation around the rotational axis (D) relative to the drive element (50).

32. The method according to claim 31, wherein step ii) further comprises
ii.1) rotating the mandrel holder (12) and the drive element (A) relative to each other around the rotational axis (D) up to an axial stop (27);
ii.2) rotating the mandrel holder (12) and the drive element (A) relative to each other around the rotational axis (D) away from the axial stop (27) until a desired rotational position of the mandrel holder (12) with respect to the drive element (A) is achieved and the locking element (50) reaches the locking position (V) in which the mandrel holder (12) is blocked against rotation around the rotational axis (D) relative to the drive element (50).

33. The method according to claim 31, further comprising
iii) sliding a tool housing (4) over the locking element (50) in order to secure the locking element (50) against a release from the locking position (V).

34. A mandrel holder (12) for a riveting device (1) according to claim 20, comprising:
a cylindrical base body (12.1) having a section (12.2) for receiving a rivet mandrel (120) or threaded rivet mandrel (220; 320) and having a threaded bore (23) for producing a screw connection (20) with the drive element (A) of the riveting device (1),
wherein the base body (12.1) has a through hole (24) which extends radially outwards from the threaded bore (23) and is set up to movably receive a locking element (50) in the direction of the threaded bore (23).

35. The mandrel holder according to claim 34,
further comprising the locking element (50) which is received in the through hole (24).

36. A blind rivet setting tool (100), comprising:
the riveting device (1) according to claim 20, and
a rivet mandrel (120) of a blind rivet (110) to be set,
wherein the rivet mandrel is received in the mandrel holder (12) of the riveting device (1).

37. A blind rivet nut setting tool (200), comprising:
the riveting device (1) according to claim 20, and
a threaded rivet mandrel (220) for a blind rivet nut (210) to be set,
wherein the threaded rivet mandrel is received in the mandrel holder (12) of the riveting device (1).

38. A blind rivet screw setting tool (300), comprising:
the riveting device (1) according to claim 20, and
a threaded rivet mandrel (320) of a blind rivet screw (310) to be set,
wherein the threaded rivet mandrel is received in the mandrel holder (12) of the riveting device (1).
